(19) United States
(12) Patent Application Publication
(10) Pub. No.: US 2006/0168550 A1
(43) Pub. Date: Jul. 27, 2006

(54) System, method and apparatus for creating and managing activities in a collaborative computing environment

(75) Inventors: Michael Muller, Medford, MA (US); Thomas P. Moran, Palo Alto, CA (US); Joann Ruvolo, San Jose, CA (US); Catalina Danis, Hastings-on-Hudson, NY (US); Daniel M. Gruen, Newton, MA (US); John C. Tang, Palo Alto, CA (US); Alex Cozzi, San Jose, CA (US); Andreas Dieberger, Los Gatos, CA (US); Stephen Farrell, San Francisco, CA (US); Beverly Harrison, Menlo Park, CA (US); Wendy Anne Kellogg, Yorktown Heights, NY (US); Suzanne Minassian, Boston, MA (US); Paul B. Moody, Hyde Park, VT (US); Robert J. Stachel, Waltham, MA (US); Hui Su, Beijing (CN); Tianshu Wang, Beijing (CN); Qiang Zhang, Beijing (CN); Chen Zhao, Beijing (CN); Charles Hill, Belmont, MA (US); Sandra Kogan, Newton, MA (US); Andrew L. Schirmer, Andover, MA (US)

Correspondence Address: CAREY, RODRIGUEZ, GREENBERG & PAUL, LLP;STEVEN M. GREENBERG, 1300 CORPORATE CENTER WAY, SUITE 105G, WELLINGTON, FL, 33414, US

(73) Assignee: International Business Machines Corporation, Armonk, NY (US)

(21) Appl. No.: 11/039,977

(22) Filed: Jan. 21, 2005

(51) Int. Cl. G06F 9/46

(52) U.S. Cl. 715/866; 718/100; 707/102

(57) ABSTRACT

A method, system and apparatus for creating and managing an activity in a collaborative environment. In a preferred aspect of the present invention, a unified activity manager for use in a collaborative environment can include an activity list including a hierarchical listing of activities. Each of the activities can include at least one task. The unified activity manager further can include an activity view including a rendering of properties associated with a selected activity in the activity view. Finally, the unified activity manager yet further can include a persons and roles view including at least a listing of collaborators available for association with the selected activity in the activity view.

### DESCRIPTION OF THE RELATED ART

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Personal information managers, project management systems and workflow management systems represent three such computing applications which attempt to manage a process leading to an objective, leveraging of the participation of many individuals in the process. Considering first the personal information manager (PIM), in a PIM, a single end user can establish a calendar of events and a to-do list of tasks which are to be performed by the end user. To the extent that a task is to be performed by another individual, the end user only can establish a task reminding the end user to monitor the completion of the task by the other individual. PIMs do permit the calendaring of events among different individuals, but the calendaring operation only can “invite” others to calendar the event within the personal information manager of other users.

Project management systems provide means for an individual or a group to define and track project stages with strictly-specified interdependencies. In a traditional project management system, the phases of a project can be defined from start to finish and a timeline can be generated for the project. Utilizing the timeline, it can be determined when particular phases of the project have been completed and when a subsequently scheduled phase of the project can begin. To the extent that the timing of one phase of the project changes, the remaining project phases can be adjusted to accommodate the changed timing. Similarly, if the project requires the use of limited resources, and the allocation of one such resource changes, the remaining project phases that depend on that resource can be adjusted to accommodate the reduction of that resource. A major strength of project management systems is their maintenance of these kinds of strict interdependencies. In addition, in many project management systems, particular people can be assigned to particular phases of the project.

In these ways, the execution of a project can be better managed by a project manager using the project management system's control over timing, resources, and people. Notably, in most project management systems, the interdependencies are specified by the project manager, and the other users are relegated to the subordinate tasks of confirming that components have been completed, or indicating changes in resources. Changes in interdependencies are typically executed only by the project manager.

Workflow management systems differ substantially from PIMs and project management systems. In a workflow management system, different computing processes can be linked together by an electronic specification. Moreover, in a workflow management system, it is not important whether all of the computing processes are managed by a single entity and different ones of the computing processes can be distributed about a network of diverse computing resources. In the latter circumstance, the specifying electronic document merely need reference the pertinent computing processes in a way in which the processes can be located in the value chain. Most importantly, a workflow specifies a structure of distributed processes, executed by a combination of electronic and human agents, with rigid contingencies that are enforced among these agents.

Learning management systems can be viewed as collaborative forms of the project manager. In a typical learning management system, a project species—namely a syllabus—can be defined to include one or more assignments. A class can be created from the syllabus, one or more instructors can be assigned to the class and one or more students can be enrolled in the class. Advantageously, additional collaborative tools can be provided to facilitate the execution of the course, including a chat room, document library and discussion forum, to name a few.

Notwithstanding the foregoing, individualized PIMs, project management systems, and workflow management systems, as well as collaborative learning management systems, do not account for the actual nature of a coordinated set of collaborative tasks conducted by people, such as an activity. An activity, unlike a typical project or workflow, refers to objects, actions, and persons in the real world, and provides a computerized representation of selected aspects of those objects, actions, and persons.

As is well known, human work is notoriously situational and changeable. Humans discover new aspects of problems, develop new understandings of constraints, adapt to changed conditions, and inform their colleagues about these new circumstances. Regarding this changeable, re-interpretable, shared human work, conventional task management systems have failed to provide a flexible, collaborative computerized representation of a coordinated set of collaborative tasks. Rather, PIMs provide merely flexible, but private representations of collaborative tasks.

By comparison, project management systems provide shared representations of project components in which one user typically specifies a fixed set of components and their interdependencies for use by other users. Furthermore, in project management systems, other users are relegated to the task of updating not the interdependencies, but merely the status of the specified components within those strict interdependencies. Accordingly, workflow systems and learning management systems provide a strictly enforced sequence of actions and keep records of deviations therefrom.

In view of the foregoing, what is needed to support actual human collaborative work is a flexible online representation such as an activity of that human work, and of the changing interpretations and interdependencies of that work. Unlike typical project management or workflow systems, such an activity system should provide guidance, coordination, and access to resources for people to carry out collaborative activities in a natural situationally-adaptive manner, and for people to change the representation of both the activity itself and its relationship to other activities.

By allowing all users to modify and refine these representations, and unlike project management systems, workflows, and learning management systems, the activity system should become an activity management system. Further, by providing access to resources that are internal and external to the activity environment, the activity management system should provide unified activity management of those representations and their resources. Activities, unlike projects or workflows, permit free variation in the completion of tasks. Thus, activities, unlike projects and workflows, are not so rigid as to require a sequential completion of each phase of a project.

### SUMMARY OF THE INVENTION

The present invention addresses the deficiencies of the art in respect to activity management and provides a novel and non-obvious method, system and apparatus for creating and managing an activity in a collaborative environment. In a preferred aspect of the present invention, a unified activity manager for use in a collaborative environment can include an activity list view including a hierarchical listing of activities. Selected ones of the activities can include a hierarchy of sub-activities. The unified activity manager further can include an activity view including a rendering of properties associated with a selected activity in the activity list view. Finally, the unified activity manager yet further can include a persons and roles view including at least a listing of collaborators available for association with the selected activity in the activity list view.

In one embodiment of the invention, the activity view further can include a listing of collaborators associated with the selected activity in the activity list view. In another embodiment of the invention, the activity view further can include a listing of roles associated with the selected activity in the activity list view. In yet another embodiment of the invention, the activity view further can include a listing of resources associated with the selected activity in the activity list view. In this regard, the resources can include at least one electronic mail message associated with the activity, at least one document associated with the activity, at least one file associated with the activity, at least one link to a workflow associated with the activity, at least one calendar entry associated with the activity, or at least one collaborative application associated with the activity.

A method for creating an activity in a collaborative environment can include establishing an activity, inserting additional activities arranged in a sub-activity linkage hierarchy into the activity, associating a collaborator with the established activity, rendering the established activity in an activity list view in the collaborative environment, and permitting access for the collaborator to the activity in the collaborative environment. The method further can include establishing additional activities in the activity list view. These additionally established activities can be independent of the initially established activity. Alternatively, these additional activities can be inserted as dependencies or components of the initially established activity.

The method yet further can accommodate changing circumstances, permitting the editing of either the description of an activity, or the interrelationships among activities. The method yet further can include inserting additional tasks in the activity, and arranging the additional tasks in a hierarchy. In this regard, at least one role can be assigned to at least one of the additional tasks in the hierarchy. Finally, it is important to note that the activity can be completed without requiring each task in the activity to be completed.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a unified activity manager which has been configured in accordance with the present invention;

FIG. 2 is a block diagram illustrating an architecture for the unified activity manager of FIG. 1;

FIG. 3A is a flow chart illustrating a process for parameterizing an activity in the unified activity manager of FIG. 2; and,

FIG. 3B is a flow chart illustrating a process for decomposing an activity in the unified activity manager of FIG. 2.

### DETAILED DESCRIPTION OF THE PREFERRED EMBODIMENTS

The present invention is a method, system and apparatus for creating and managing an activity in a collaborative environment. In accordance with the present invention, an activity can be established and one or more tasks can be specified for the activity. The task defines work to be done, and the activity provides data, metadata, functionality, and links to manage the completion of that task. An original activity may be decomposed into one or more additional, dependent activities, each of which is linked to the original activity through a subactivity-relationship, and each of which may have one or more tasks specified for the respective activity.

At least one collaborator can be assigned to at least one of the activities. Optionally, in lieu of assigning a collaborator to a activity, a role can be assigned to the activity which role can be filled by a collaborator characterized by the role. Importantly, one or more resources also can be assigned to one or more of the activities, where each assigned resource can be utilized in the course of completing an assigned activity. To that end, the resources can include documents, collaborative tools and workflow links, to name only a few.

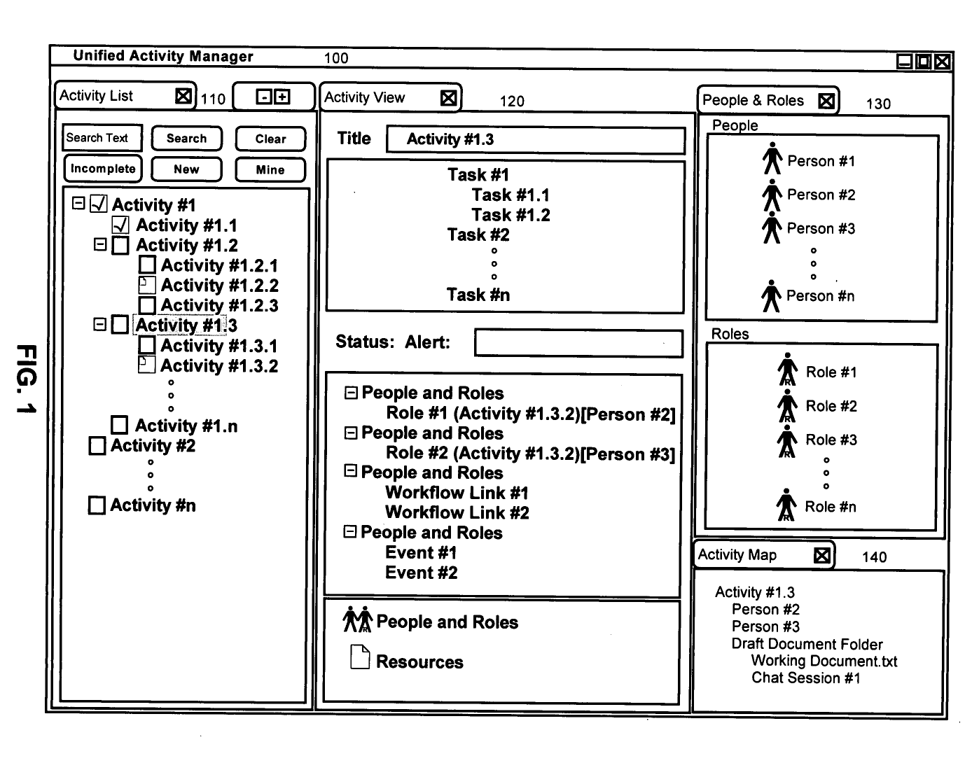

In further illustration, FIG. 1 is a pictorial illustration of a unified activity manager which has been configured in accordance with the present invention. The unified activity manager 100 can include several views including an activity list view 110, an activity view 120 and a people and roles view 130. The activity list view 110 can include a listing of one or more activities. Each activity can be decomposed into zero or more dependent activities, which together comprise a richer description of the work summarized in the original activity. Each of these dependent activities is itself an activity, but appears in a subactivity-relationship to the original activity. This process of defining activities in subactivity-relationship may be extended to any desired level of dependent description.

The activity view 120 can include a description of a task that is contained within the activity. The task description can include one or more tasks associated with the activity. Additionally, tasks can be decomposed into zero or more dependent tasks, which together comprise a richer procedural specification of the original task. Each of these dependent tasks is itself a task, but appears in a subtask-relationship to the original task. This process of specifying tasks in subtask-relationship may be extended to any desired level of dependent specification.

The activity view 120 further can include a detailed listing of the properties of a selected activity in the activity list view 110. Specifically, the detailed listing can include a listing of collaborators (people) specified for the activity. Also, the detailed listing can include a listing of collaborator roles (roles) specified for the activity. Further, the detailed listing can include a listing of events specified for the activity. Finally, the detailed listing can include a listing of links to internal workflows, external workflows or both.

Finally, the peoples and roles view 130 can include a listing of collaborators in the collaborative environment available for assignment to a specified activity in the activity list view 110. The peoples and roles view 130 also can include a listing of collaborative roles in the collaborative environment available for assignment to a specified activity in the activity list view 110. In this regard, a role can be compared to a person in that a person references a specific identity and a role references only a class of persons.

Finally, an activity map 140 can be provided. The activity map 140 can include an arranged set of electronic mail messages, calendar entries, documents, files and file folders, and applications, such as an application share, discussion thread or chat session, to name a few.

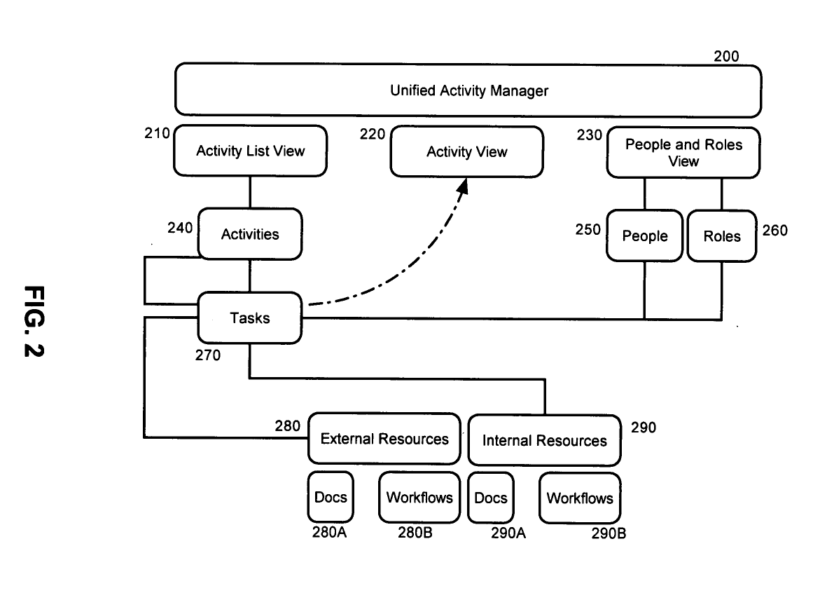

Turning now to FIG. 2, a block diagram is shown which illustrates the architecture for the unified activity manager of FIG. 1. The architecture can include the unified activity manager 200 which can have an activity list view 210, an activity view 220 and a people and roles view 230. The activity list view 210 can include one or more activities 240, each activity 240 having one or more tasks 270 or even other activities 240 defined through a sub-activity relationship. The activity view 220 can include a visual rendering of the properties of a selected one of the activities 270. Finally, the people and roles view 230 can include one or more people 250 and one or more roles 260. Importantly, references to the people 250 and roles 260 can be included in the tasks 270.

In accordance with the present invention, each of the activities 270 optionally can include links to both internal resources 280 and external resources 290. The internal resources 280 can include internally disposed documents 280A and internally specified workflows 280B to name only two. Similarly, the external resources 290 can include externally disposed documents 290A and externally specified workflows 290B. Other resources not shown can include references to internally available collaborative tools including application shares, chat sessions, document libraries, and e-mail messages, to name a few.

Utilizing the architecture of FIG. 2, activities can be created and managed so as to facilitate the collaborative achievement of a goal without requiring the use of a rigid, non-collaborative, conventional workflow or project management system. Rather, the activities can represent an informal and flexible structuring of to-dos and resources which can permit the collaborative execution of the activity in a conversational manner, regardless of the sequence of completion of the to-dos and irrespective of whether all tasks in the activity are completed.

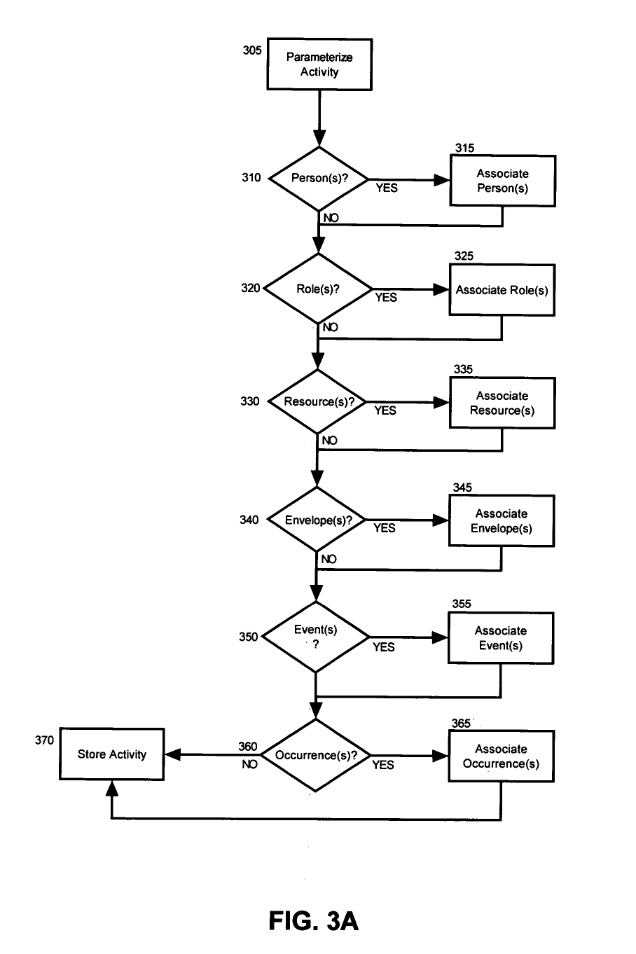

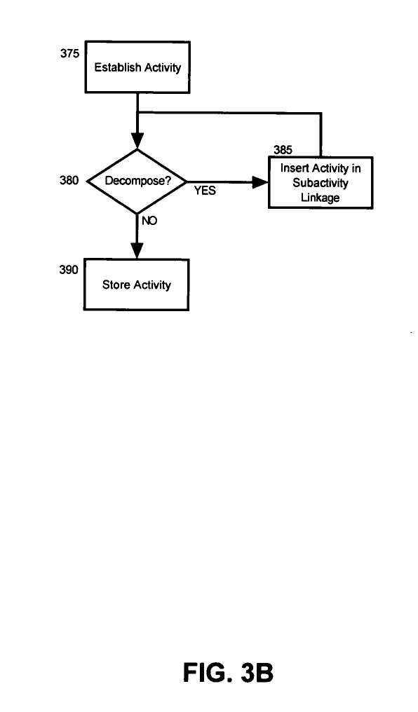

In further illustration, FIG. 3A is a flow chart illustrating a process for parameterizing an activity in the unified activity manager of FIG. 2. Beginning in block 305, an activity can be selected for parameterization. In decision block 310, it can be determined whether one or more persons are to be association with the activity and, if so, in block 315 one or more persons can be associated with the activity. Likewise, in decision block 320, it can be determined whether one or more roles are to be associated with the activity and, if so, in block 325 one or more roles can be associated with the activity.

In block 330, it can be determined whether any resources are to be associated with the activity. The resources can include, but are not limited to documents, messages, collaborative applications, or workflow links. If so, in block 335 the resources can be associated with the activity. Similarly, in decision block 340 it can be determined whether any resource placeholders, referred to as “envelopes”, are to be associated with the activity. If so, in block 345 the envelopes can be associated with the activity. Also, in decision block 350 it can be determined whether any events are to be associated with the activity. If so, in block 355 the events can be associated with the activity. Finally, in decision block 360 it can be determined whether any event placeholders, referred to as “occurrences”, are to be associated with the activity. If so, in block 365 the occurrences can be associated with the activity. Finally, in block 370 the activity can be stored.

Turning now to FIG. 3B, a flow chart is shown which illustrates a process for decomposing an activity in the unified activity manager of FIG. 1. Beginning in block 370, an activity can be established. In decision block 375, it can be determine whether the activity is to be decomposed into a hierarchy of constituent sub-activities. If the activity is to be decomposed into a hierarchy of constituent sub-activities, in block 385 a new activity can be inserted into a sub-activity linkage for the established activity and the process can repeat through decision block 380. Otherwise, in block 390 the completed activity can be stored.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A unified activity manager for use in a collaborative environment comprising:
an activity list view comprising a listing of activities, each of said activities comprising at least one task;
an activity view comprising a rendering of properties associated with a selected activity in said activity list view; and,
a persons and roles view comprising at least a listing of collaborators available for association with said selected activity in said activity list view.

2. The unified activity manager of claim 1, wherein said activity view further comprises a listing of collaborators associated with said selected activity in said activity list view.

3. The unified activity manager of claim 1, wherein said activity view further comprises a listing of roles associated with said selected activity in said activity list view.

4. The unified activity manager of claim 1, wherein said activity view further comprises a listing of resources associated with said selected activity in said activity list view.

5. The unified activity manager of claim 4, wherein said resources comprise at least one document associated with said activity.

6. The unified activity manager of claim 4, wherein said resources comprise at least one file associated with said activity.

7. The unified activity manager of claim 4, wherein said resources comprise at least one link to a workflow associated with said activity.

8. The unified activity manager of claim 4, wherein said resources comprise at least one event associated with said activity.

9. The unified activity manager of claim 4, wherein said resources comprise at least one collaborative application associated with said activity.

10. The unified activity manager of claim 1, further comprising an activity map.

11. The activity manager of claim 1, wherein said persons and roles view further comprises a listing of roles available for association with said selected activity in said activity list view in lieu of associating a collaborator with said selected activity.

12. A method for creating an activity in a collaborative environment, the method comprising the steps of:
establishing an activity in an activity list view;
associating a collaborator with said established activity;
rendering said established activity in said activity list view in the collaborative environment; and,
permitting access for said collaborator to said established activity in the collaborative environment.

13. The method of claim 12, further comprising the step of establishing additional activities in said activity list view, wherein each said established additional activity is independent of other activities in said activity list.

14. The method of claim 12, further comprising the step of inserting additional activities in said activity according to a sub-activity linkage hierarchy.

15. The method of claim 12, further comprising the step of re-arranging said sub-activity linkage hierarchy.

16. The method of claim 12, further comprising the step of completing said activity without requiring each of said additional activities in said activity to be completed.

17. The method of claim 13, further comprising the step of assigning at least one role to at least one of said additional activities in said sub-activity linkage hierarchy.

18. A machine readable storage having stored thereon a computer program for creating an activity in a collaborative environment, the computer program comprising a routine set of instructions which when executed by a machine, causes the machine to perform the steps of:
establishing an activity in an activity list view;
associating a collaborator with said established activity;
rendering said established activity in said activity list view in the collaborative environment; and,
permitting access for said collaborator to said established activity in the collaborative environment.

19. The machine readable storage of claim 18, further comprising an additional set of instructions which when executed by the machine causes the machine to further perform the step of establishing additional activities in said activity list view, wherein each said established additional activity is independent of other activities in said activity list.

20. The machine readable storage of claim 19, further comprising an additional set of instructions which when executed by the machine causes the machine to further perform the step of inserting additional activities in said activity according to a sub-activity linkage hierarchy.

21. The machine readable storage of claim 18, further comprising an additional set of instructions which when executed by the machine causes the machine to further perform the step of re-arranging said sub-activity linkage hierarchy.

22. The machine readable storage of claim 18, further comprising an additional set of instructions which when executed by the machine causes the machine to further perform the step of completing said activity without requiring each of said additional activities in said activity to be completed.

23. The machine readable storage of claim 19, further comprising an additional set of instructions which when executed by the machine causes the machine to further perform the step of assigning at least one role to at least one of said additional activities in said sub-activity linkage hierarchy.
